(19) United States
(12) Patent Application Publication
(10) Pub. No.: US 2025/0390304 A1
(43) Pub. Date: Dec. 25, 2025

(54) SYSTEMS AND METHODS FOR EXECUTING AN INSTRUCTION BY AN ARITHMETIC LOGIC UNIT PIPELINE

(71) Applicant: Advanced Micro Devices, Inc., Santa Clara, CA (US)

(72) Inventors: Yasuko Eckert, Bellevue, WA (US); Travis Boraten, Austin, TX (US); Michael Estlick, Fort Collins, CO (US); Heather Lynn Hanson, Austin, TX (US); Gabriel H. Loh, Bellevue, WA (US)

(73) Assignee: Advanced Micro Devices, Inc., Santa Clara, CA (US)

(21) Appl. No.: 18/753,480

(22) Filed: Jun. 25, 2024

(51) Int. Cl. G06F 9/30; G06F 7/57

(52) U.S. Cl. CPC G06F 9/3001; G06F 7/57; G06F 9/30112

(57) ABSTRACT

A method for executing an instruction by an arithmetic logic unit pipeline can include performing, by permutation circuitry, a permutation in response to an instruction that includes an arithmetic operation. The method can also include performing, by an arithmetic logic unit, the arithmetic operation in response to the instruction. Various other methods and systems are also disclosed.

### BACKGROUND

Processing units, such as central processing units (CPUs) and co-processing units (e.g., graphics processing units (GPUs), accelerator processing units (APUs), etc.) can include control units, arithmetic logic units (ALUs), caches, and/or memory (main memory, random access memory (RAM), etc.). A useful division that computer architects can use with respect to such processors is that of “front end” and “back end” (e.g., “execution engine”). The front end can correspond to control units and input/output units of a programming model and the back end can correspond to one or more ALUs. Instructions can generally make their way from the cache through the front end to the back end that executes the instructions. For example, a scheduler in the front end can fetch instructions from a cache or main memory and a decoder, also in the front end, can decode the instructions for execution by the backend.

Instructions that processors execute can take various forms, such as macro-operations (macro-op), micro-operations (micro-op or pop), etc. Instructions can include operation codes (opcodes) (e.g., instruction machine codes, instruction codes, instruction syllables, instruction parcels, opstrings, etc.). An opcode can generally refer to a portion of a machine language instruction that specifies an operation to be performed and that can be performed in a single instruction. Besides the opcode itself, most instructions also specify data to be processed in the form of operands (e.g., register values, stack values, memory values, etc.). Types of operations can include arithmetic, data copying, logical operations, program control, special instructions, etc. In this context, a micro-op can generally refer to a simple, single operation (e.g., a single arithmetic or memory operation), and these micro-ops can make up a potentially more complex macro-operation that requires multiple instruction cycles to perform.

Various pipeline models are often used to design and implement a processor instruction flow and/or portions thereof. For example, a four stage pipeline for instruction flow can include caches, front end, backend, and retire/write (e.g., retire stage, retire unit). However, this four stage pipeline can further be expanded into more pipelines/stages, such as a decoder pipeline in the front end and/or an ALU pipeline in the backend. These further divisions can be useful for distinguishing the ALU pipeline, for example, from other pipelines in the backend, such as a load-store unit (LSU) pipeline and/or a floating point unit (FPU) pipeline.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a flow diagram of an example method for executing an instruction by an arithmetic logic unit pipeline.

FIG. 2 is a block diagram illustrating processing units implementing a processor instruction pipeline including an arithmetic logic unit pipeline for executing an instruction.

FIG. 3 is a block diagram illustrating a processor instruction pipeline including an arithmetic logic unit pipeline for executing an instruction.

FIG. 4 is a block diagram illustrating arithmetic logic unit pipelines for executing an instruction.

FIG. 5 is a block diagram illustrating arithmetic logic unit pipelines for executing an instruction.

FIG. 6 is a block diagram illustrating arithmetic logic unit pipelines for executing an instruction.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

In an instruction pipeline, there can be dependent instruction sequences in which a permute instruction is followed by an arithmetic instruction. The arithmetic instruction can reads and overwrite the output of the permute instruction. These two instructions currently cannot be executed in a single ALU pipeline due to two separate ALU executions, consuming two scheduler entries and associated picker overhead. Executing permute and arithmetic operations in more than one ALU pipeline can result in higher instruction count and increased resource (e.g., scheduler) pressure.

The present disclosure is generally directed to systems and methods for executing an instruction by an arithmetic logic unit pipeline. For example, by performing, by permutation circuitry, a permutation in response to an instruction specifying a single operation that includes an arithmetic operation and performing, by an arithmetic logic unit (ALU), the arithmetic operation in response to the instruction, the disclosed systems and methods can achieve numerous benefits. For example, certain implementations of the disclosed systems and methods can reduce the number of instruction cycles required to execute two or more dependent instructions that involve a permutation and an arithmetic operation by fusing them into a single instruction. Executing both permute and arithmetic operations in a single ALU pipeline can result in lower instruction count and reduced resource (e.g., scheduler) pressure. Additional benefits can include latency improvement, reduced contention, and reduced instruction count (e.g., for implementations having an explicit instruction set architecture (ISA) instruction).

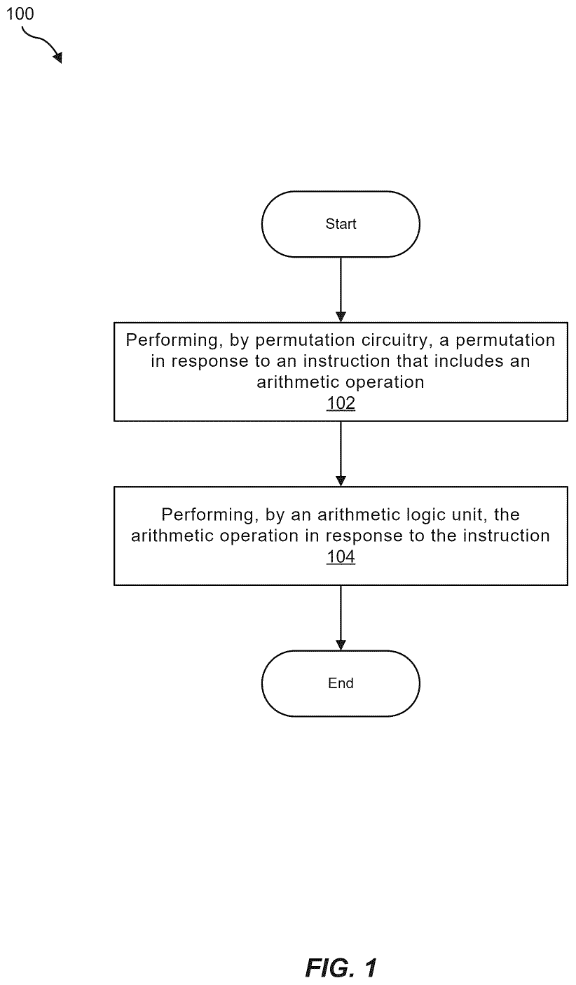

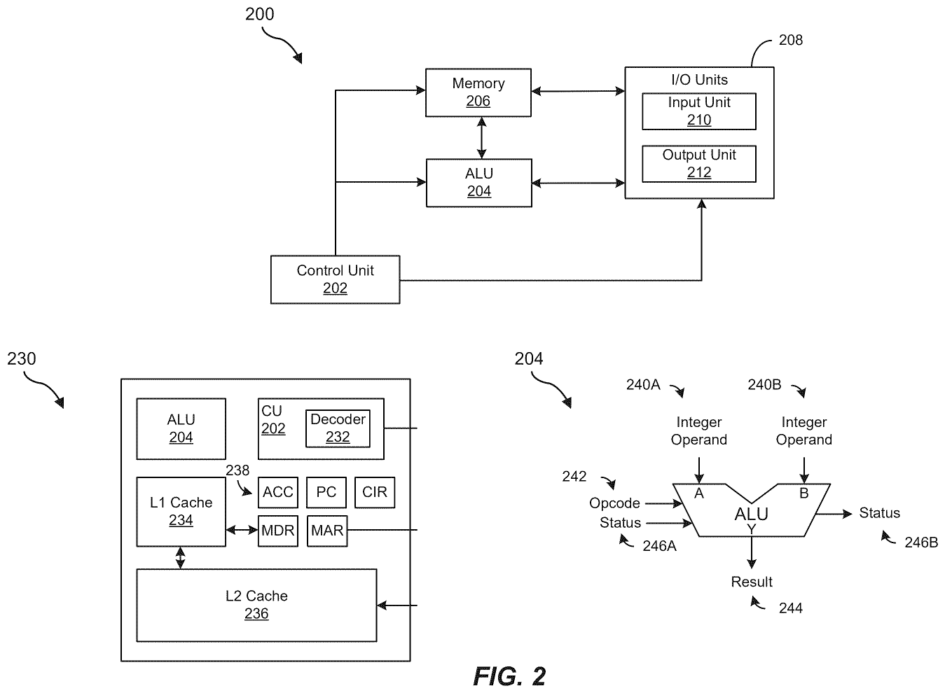

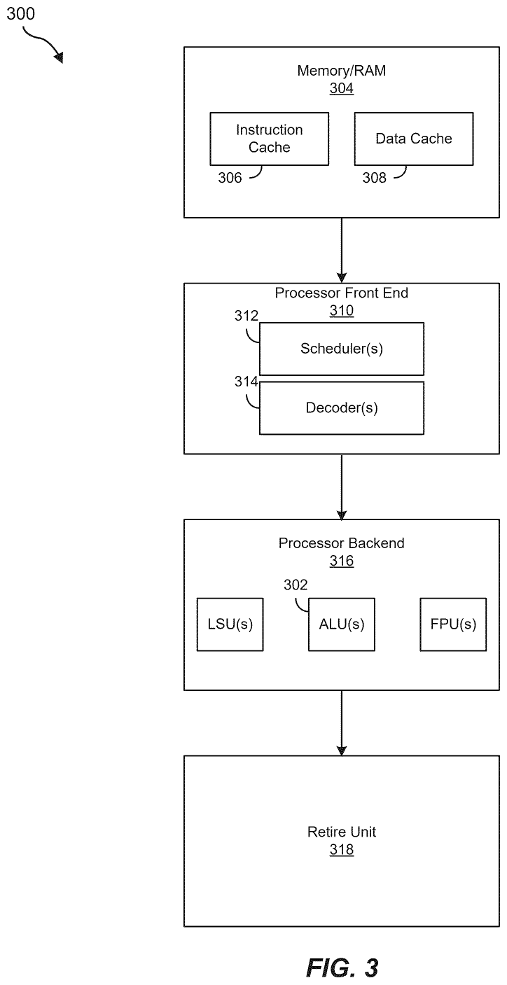

The following will provide, with reference to FIG. 1, detailed descriptions of methods for executing an instruction by an ALU pipeline. In addition, detailed descriptions of example processor instruction pipelines will be provided in connection with FIG. 2. Also, detailed descriptions of example ALU pipelines will be provided in connection with FIGS. 3-5.

In one example, a device can include permutation circuitry configured to perform a permutation in response to an instruction that includes an arithmetic operation and an arithmetic logic unit configured to perform the arithmetic operation in response to the instruction.

Another example can be the previously described example device, wherein the permutation circuitry is configured to perform a zero amount of permutation based on a static value that is included in the instruction and that indicates a zero value.

Another example can be any of the previously described example devices, wherein the permutation circuitry is configured to perform the permutation on a first source variable based on static value, the first source variable and the static value being specified by the instruction.

Another example can be any of the previously described example devices, wherein the arithmetic logic unit is configured to perform the arithmetic operation on the permuted first source variable and a second source variable, the arithmetic operation and the second source variable also being specified by the instruction.

Another example can be any of the previously described example devices, wherein the arithmetic logic unit is configured to perform the arithmetic operation on a first source variable and a second source variable, the first source variable and the second source variable being specified by the instruction and the permutation circuitry is configured to perform the permutation on an output of the arithmetic logic unit based on a static value specified by the instruction.

Another example can be any of the previously described example devices, wherein the arithmetic logic unit is configured to store its output to a first destination register; and the permutation circuitry is configured to store its output to a second destination register.

Another example can be any of the previously described example devices, wherein the permutation circuitry is configured to perform the permutation within a first word size less than a second word size within which the arithmetic logic unit is configured to perform additional permutations.

Another example can be any of the previously described example devices, wherein the device is further configured to fuse two or more dependent instructions that involve one or more permutations at least one of before or after the arithmetic operation into the instruction.

Another example can be any of the previously described example devices, wherein the device is configured to store the instruction in a cache.

Another example can be any of the previously described example devices, wherein the device is configured to disable fusing in response to at least one of an interrupt or an exception raised while executing the instruction.

Another example can be any of the previously described example devices, further including a multiplexer configured to receive an input to the permutation circuitry, receive an output of the permutation circuitry, and provide only one of the received input or the received output to the arithmetic logic unit.

In one example, a system can include a fusion logic unit configured to fuse two or more dependent instructions that involve one or more permutations at least one of before or after an arithmetic operation into an instruction that includes the arithmetic operation and one or more arithmetic logic unit pipelines, wherein at least one of the one or more arithmetic logic unit pipelines includes permutation circuitry configured to perform a permutation in response to the instruction and an arithmetic logic unit configured to perform the arithmetic operation in response to the instruction.

Another example can be the previously described example system, further including a cache configured to store the instruction.

Another example can be any of the previously described example systems, wherein the two or more dependent instructions are identified by at least one of one or more schedulers of a processor back end, one or more decoders of a processor front end, or a retire unit.

Another example can be any of the previously described example systems, wherein the permutation circuitry is configured to perform a zero amount of permutation based on a static value that is included in the instruction and that indicates a zero value.

In one example, a method can include performing, by permutation circuitry, a permutation in response to an instruction that includes an arithmetic operation and performing, by an arithmetic logic unit, the arithmetic operation in response to the instruction.

Another example can be the previously described example method, further comprising performing a zero amount of permutation based on a static value that is included in the instruction and that indicates a zero value.

Another example can be any of the previously described example methods, further including performing the permutation on a first source variable based on a static value, the first source variable and the static value being specified by the instruction.

Another example can be any of the previously described example methods, further including performing the permutation, by the permutation circuitry, within a first word size less than a second word size within which the arithmetic logic unit is configured to perform additional permutations.

Another example can be any of the previously described example methods, further including fusing two or more dependent instructions that involve one or more permutations at least one of before or after the arithmetic operation into the instruction.

FIG. 1 is a flow diagram of an example method 100 for executing an instruction by an ALU pipeline. Beginning at step 102, method 100 can perform a permutation. For example, method 100 can, at step 102, perform, by permutation circuitry, a permutation in response to an instruction that includes an arithmetic operation.

The term “permutation,” as used herein, can generally refer to an operation that rearranges an order of terms in a sequence. For example, and without limitation, a permutation can correspond to or include a shift or a shuffle. In this context, permutation can be employed as part of bit manipulation and/or vector processing (e.g., gather-scatter) to copy contents from a source array to a destination array, where the indices are specified by a second source array.

The term “performing a permutation,” as used herein, can entail performing a non-zero amount of permutation and/or performing a zero amount of permutation. For example, performing a non-zero amount of permutation can include executing a permutation by shifting bits of a (e.g., binary) number one or more places to the left or right. In another example, performing a non-zero amount of permutation can include skipping execution of a permutation or executing the permutation without shifting bits of a (e.g., binary) number one or more places to the left or right. In this context, executing a permutation without shifting can correspond to multiplying or dividing a number by one, adding zero to a number, or subtracting zero from a number.

The term “permutation circuitry,” as used herein, can generally refer to special purpose circuitry that performs permutations in an ALU pipeline, without all of the functionality of an ALU (e.g., the capability to perform other types of arithmetic operations). For example, and without limitation, permutation circuitry can correspond to lightweight hardware logic implemented before and/or after an ALU in an ALU pipeline. In some implementations, the permutation circuitry can reduce additional area overheads to the ALU and minimize latency overhead to other instructions that do not require permute by limiting the permutation capability to be within a fixed/limited word size (e.g., sixty-four bits, one-hundred twenty-eight bits, etc.) and by taking an immediate value as an input as opposed to a permute index register.

The term “instruction,” as used herein, can generally refer to a micro-operation containing a single opcode that specifies an arithmetic operation. For example, and without limitation, the instruction can contain a single opcode that specifies an arithmetic operation such as addition, subtraction, multiplication, or division. In some implementation, the instruction can include two or more source variables and at least one immediate input that indicates an amount of permutation to be applied to at least one of the source variables.

The term “single operation,” as used herein, can generally refer to a portion of a machine language instruction (e.g., opcode) that specifies an operation to be performed and that can be performed in a single instruction. For example, and without limitation, a single operation can include an arithmetic operation, a data copying operation, a logical operation, a program control operation, special instructions, etc. In this context, the single operation referred to can include an arithmetic operation.

The term “arithmetic operation,” as used herein, can generally refer to a basic operation in arithmetic. For example, and without limitation, an arithmetic operation can correspond to addition, subtraction, multiplication, or division.

Method 100 can perform step 102 in a variety of ways. In one example, the performance of the permutation at step 102 can be optional. In some of these implementations, method 100 can, at step 102, avoid performing an additional permutation in response to an additional instruction specifying an additional single operation that includes an additional arithmetic operation. In some of these implementations, method 100 can, at step 102, avoid performing the additional permutation in response to an immediate input specified by the additional instruction having a predetermined value. In some of these implementations, the predetermined value can correspond to a zero amount of permutation. In another example, method 100 can, at step 102, perform the permutation, by the permutation circuitry, within a first word size (e.g., sixty-four bits, one-hundred twenty-eight bits, etc.) less than a second word size within which an arithmetic logic unit is configured to perform additional permutations. In one example, method 100 can, at step 102, perform the permutation, by the permutation circuitry, on a first source variable based on an immediate input, the first source variable and the immediate input being specified by the instruction. In some of these implementations, the permutation circuitry can precede an ALU in an ALU pipeline. In one example, method 100 can, at step 102, perform the permutation, by the permutation circuitry, on an output of an ALU based on an immediate input specified by the instruction. In some of these implementations, the ALU can precede the permutation circuitry in the ALU pipeline. In one example, method 100 can, at step 102, store an output of the permutation circuitry to a different destination register than one to which an arithmetic logic unit stores its output.

The term “source variable,” as used herein, can generally refer to a variable from which a value should be read. For example, and without limitation, a source variable can correspond to a register index, a memory location, an address, etc. from which a value should be read, retrieved, received, etc.

The term “immediate input” as used herein, can generally refer to a static value as opposed to a variable. For example, and without limitation, a source variable may be read (e.g., from a register index), converted to an immediate input, and provided in an instruction instead of the source variable (e.g., the register index).

The term “arithmetic logic unit,” as used herein, can generally refer to a unit in a computer which carries out arithmetic, bit shifting, and/or logical operations. For example, and without limitation, an arithmetic logic unit can include storage registers, operations logic, and sequencing logic. In this context, an arithmetic logic unit (ALU) can correspond to a combinational digital circuit that performs arithmetic and bitwise operations on integer binary numbers. This is in contrast to a floating-point unit (FPU), which operates on floating point numbers, or a load-store unit (LSU). Arithmetic operations can include bit addition and subtraction. Although multiplication and division are sometimes used, these operations are more expensive to make. Multiplication and subtraction can also be performed by repetitive additions and subtractions, respectively. Bit shifting operations can pertain to shifting the positions of the bits by a certain number of places either towards the right or left, which can be considered multiplication or division operations. Logical operations can include operations such as AND, OR, NOT, XOR, NOR, NAND, etc.

The term “arithmetic logic unit pipeline,” as used herein, can generally refer to one instruction execution hardware pathway. For example, and without limitation, an ALU pipeline can break down arithmetic operations into stages and be implemented as part of an instruction pipeline that breaks down an instruction execution process into stages. In some examples, an ALU pipeline can correspond to one instruction execution hardware pathway among multiple, parallel instruction execution hardware pathways.

The term “destination register,” as used herein, can generally refer to a small amount of storage available as part of a processor. For example, and without limitation, a destination register can correspond to a quickly accessible location available to a computer's processor and that has been designated as a storage location for an output of an instruction. In this context, processors can include, in addition to other registers (e.g., general purpose registers, instruction registers, memory address registers, memory data registers, etc.), an accumulator in which intermediate arithmetic and logic results can be stored.

At step 104, method 100 can perform the arithmetic operation. For example, method 100 can, at step 104, perform, by an arithmetic logic unit, the arithmetic operation in response to the instruction.

Method 100 can perform step 104 in a variety of ways. In one example, method 100 can, at step 104, perform the arithmetic operation on the permuted first source variable and a second source variable, the arithmetic operation and the second source variable also being specified by the instruction. In some of these implementations, the permutation circuitry can precede the ALU in the ALU pipeline. In another example, method 100 can, at step 104, perform the arithmetic operation on the first source variable and a second source variable, the first source variable and the second source variable being specified by the instruction. In some of these implementations, the ALU can precede the permutation circuitry in the ALU pipeline. In one example, method 100 can, at step 104, store an output of the ALU to a different destination register than one to which the permutation circuitry stores its output.

Method 100 can, at step 102 and/or 104, perform one or more additional operations. In one example, method 100 can, at step 102 and/or step 104, fuse two or more dependent instructions that involve one or more permutations at least one of before or after the arithmetic operation into the instruction. In some of these implementations, method 100 can identify the instructions to be fused and/or perform the fusion by a processor front end (e.g., by one or more decoders of a processor front end), by a processor back end (e.g., by one or more schedulers of a processor back end), and/or by a processor instruction pipeline (e.g., by a retire unit (e.g., retire stage) of a processor instruction pipeline). In some of these implementations, method 100 can, at step 102 and/or step 104, fuse multiple instructions by retrieving a source variable (e.g., from a permute index register) that represents an amount of permutation and providing the retrieved source variable as an immediate input in the instruction. In one example, method 100 can, at step 102 and/or step 104, store the instruction (e.g., the fused instruction) in a cache (e.g., an instruction cache, up cache, SRAM, buffer, temporary storage, etc.). In one example, method 100 can, at step 102 and/or step 104, disable fusing in response to at least one of an interrupt or an exception raised while executing the instruction. In some of these implementations, method 100 can disable the fusion by a processor front end (e.g., by one or more decoders of a processor front end), by a processor back end (e.g., by one or more schedulers of a processor back end), and/or by a processor instruction pipeline (e.g., by a retire unit (e.g., retire stage) of a processor instruction pipeline). In one example, method 100 can, at step 102 and/or step 104, receive, by a multiplexer, an input to the permutation circuitry, receive, by the multiplexer, an output of the permutation circuitry, and provide, by the multiplexer, only one of the received input or the received output to the arithmetic logic unit.

FIG. 2 illustrates processing units 200, 230, and ALU 204 implementing a processor instruction pipeline including an arithmetic logic unit pipeline for executing an instruction. Processing unit 200 can represent a central processing unit (CPU) and/or a co-processing unit (e.g., graphics processing units (GPUs), accelerator processing units (APUs), etc.). A CPU can include a control unit 202, an ALU 204, and a memory unit 206. The ALU 204 and memory unit 206 can exchange data with input-output (I/O) units 208 (e.g., input unit 210 and output unit 212). The ALU 204, memory unit 206, and IO unit 208 can exchange the data under control of the control unit 202. By comparison, a co-processing unit can include parallel control units (e.g., often less complex than a control unit in a CPU), memory units, and ALUs that can be optimized for performing particular types of operations, such as graphics processing.

Processing unit 230 illustrates an implementation of processing unit 200 and shows components of processing unit 200 in greater detail. For example, processing unit 230 can include ALU 204 and a control unit 202, which can include a decoder 232. Additionally, components of memory unit 206 can include level one (L1) cache 234, level two (L2) cache 236, and various registers 238. Registers are a type of memory of a relatively small size measured by the number of bits they can hold. For example, registers can correspond to eight bit registers, thirty-two bit registers, sixty-four bit registers, etc. Example types of registers can include program counter (PC) registers, memory address registers (MAR), memory data registers (MDR), current instruction registers (CIR), general purpose registers, data registers floating point (FP) registers, vector registers, etc. Results generated by an ALU can be stored in one or more registers 238.

ALU 204 can correspond to a general purpose ALU or a specialized ALU optimized for performing particular types of operations in parallel with other ALUs. ALU 204 can be configured to take various types of inputs, such as integer operands 240A and 240B and an opcode 242. Based on these inputs, combinatorial gates of ALU 204 can perform an arithmetic, bit shifting, and/or logical operation and generate result 244, which can be stored in ACC register 238. General-purpose ALUs can also have status signals 246A and 246B. These status signals 246A and 246B can correspond to status information from a previous operation. Example status signals 246A and 246B can include carry-out, zero, negative, overflow, parity, etc.

FIG. 3 illustrates a processor instruction pipeline 300 including an arithmetic logic unit pipeline 302 for executing an instruction. The processor instruction pipeline 300 can include memory/RAM 304, such as an instruction cache 306 and a data cache 308, a processor front end 310 that includes one or more decoders 314 and one or more schedulers 312, a processor backend 316, and a retire unit 318 (e.g., retire stage, write stage, etc.).

Instructions can generally make their way from the instruction cache 306 through the front end 310 to the back end 316 that executes the instructions. For example, a scheduler 312 in the front end can fetch instructions from the instruction cache 306 or main memory and a decoder 314, also in the front end 310, can decode the instructions for execution by the backend 316. Control unit 202 of FIG. 2 can implement the scheduler 312 and decoder 314, and ALU pipeline 302 can include the ALU 204 and ACC register 238 of FIG. 2. The ALU pipeline 302 and/or vector registers (e.g., in a floating point (FP unit) can receive the integer operands 240A and 240B and opcode 242 of FIG. 2 from the decoder 314, generate the result 244, and store the result 244 in the ACC register 238. Control unit 202 can further implement a retire unit 318 than can retire executed instructions, write results from the ACC register 238 to cache, etc.

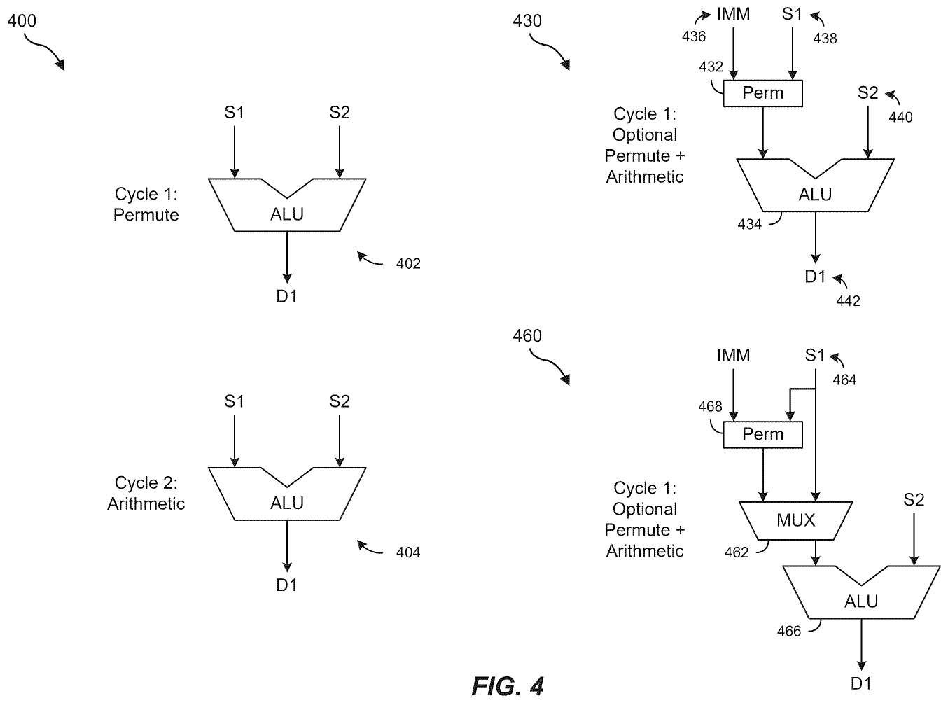

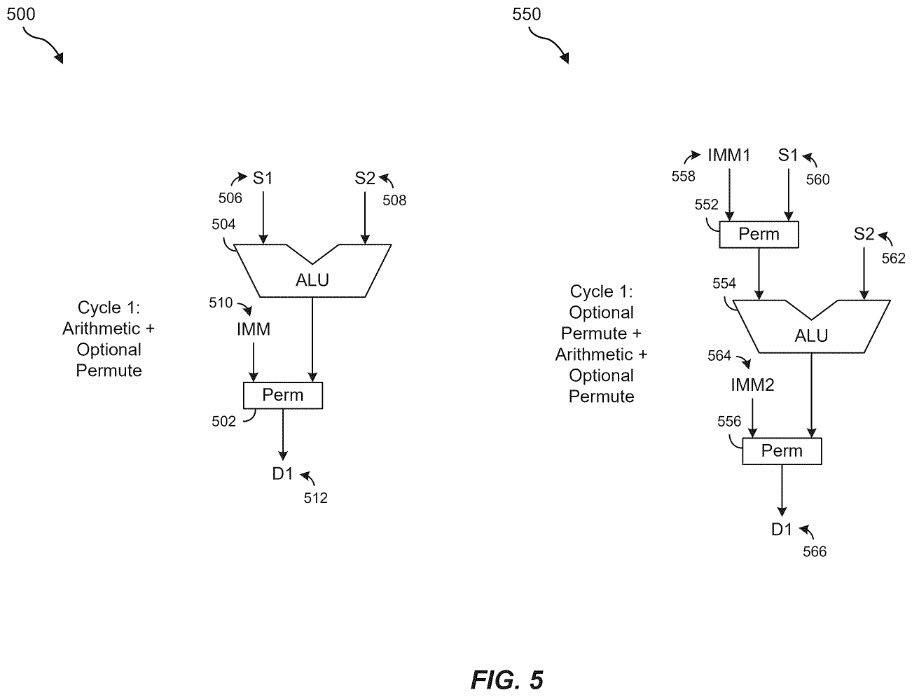

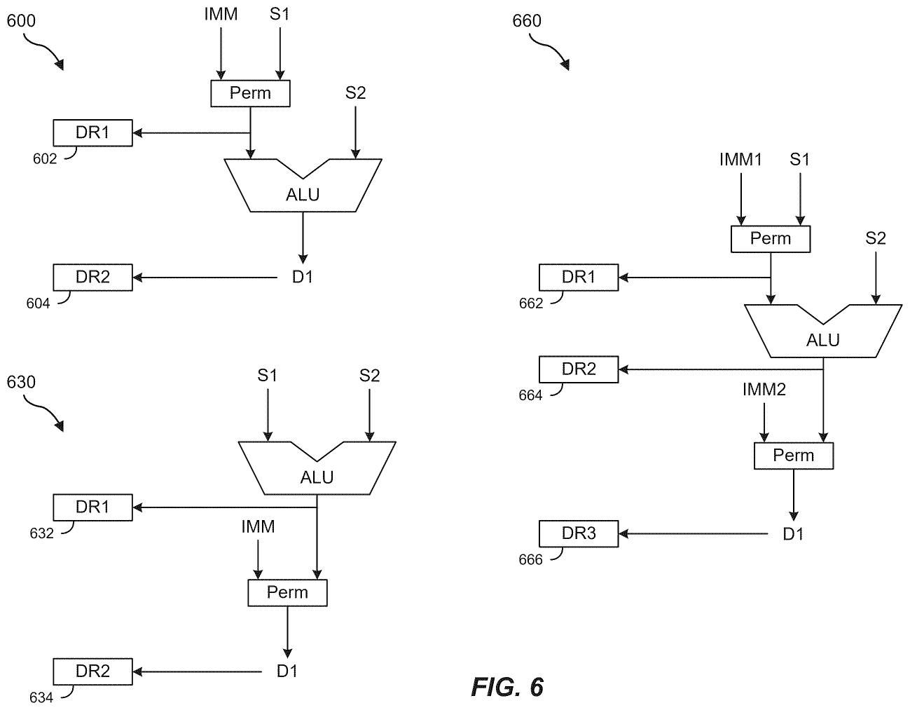

FIG. 4 illustrates ALU pipelines 400, 430, and 460 for executing an instruction. The integer operands received by the ALU pipelines 400, 430, and 460 are referred to herein as source variables, which can correspond to register addresses from which the integer operands can be retrieved for performing an operation specified by an opcode of the instruction. Additionally, the results generated by the ALU pipelines 400, 430, and 460 are referred to herein as outputs. This distinction is further employed in description of FIGS. 5 and 6. Use of this terminology can aid in distinguishing between variables and immediate inputs, between inputs to ALU pipelines versus inputs received by individual ALUs of the ALU pipelines, and between outputs of the ALU pipelines versus outputs of individual ALUs of the ALU pipelines. In this context, and as will be become apparent below, the inputs to some implementations of ALU pipelines disclosed herein may or may not correspond to inputs directly received by ALUs of the ALU pipelines. Similarly, and as will be shown in FIGS. 5 and 6 and later described with reference thereto, the outputs of some implementations of the ALU pipelines disclosed herein may or may not correspond to results generated by ALUs of the ALU pipelines.

ALU pipeline 400 can execute two dependent instructions that involve a permutation before an arithmetic operation but must do so using two cycles to perform these two sequential instructions. In this context, there can be dependent instruction sequences in which a permute instruction is followed by an arithmetic instruction, which reads and overwrites the output of the permute instruction. These two instructions currently cannot be executed simultaneously in a single ALU pipeline due to two separate ALU executions, consuming two scheduler entries and associated picker overhead. Example instructions of this type can correspond to:

fkppermilpdimm R1←R1,imm

fkaddss R1←R1,R2

where fkppermilpdimm represents a permutation operation opcode, fkadds represents an addition operation opcode, imm represents an immediate field corresponding to an amount of permutation (e.g., an amount of bit shift to left or right), and R1 and R2 represent source variables (e.g., register addresses). The permute amount can indicate permutation to be applied to R1 and the source variables can indicate register addresses from which integer operands can be retrieved and results can be stored.

In a first cycle 402, ALU pipeline 400 can perform the permutation operation taking R1 and imm as source variables S1 and S2 and store a result of the permutation in a destination register at an address from which R1 was retrieved by ALU pipeline 400. In a second cycle 404 (e.g., subsequent to the first cycle 402), ALU pipeline can perform the addition operation taking R1 and R2 as the source variables S1 and S2 and store a result of the addition in the destination register at the address for R1. Requiring two cycles to execute the two dependent instructions that involve a permutation before an arithmetic operation consumes processor resources due to instruction count and scheduler utilization.

In contrast to ALU pipeline 400, ALU pipeline 430 can include permutation circuitry 432 (e.g., lightweight and optional permute logic) positioned before an ALU 434 in the ALU pipeline 430, resulting in lower instruction count and reduced resource (e.g., scheduler) pressure. Permutation circuitry 432 can include gates configured to perform permutation operations within a fixed/limited word size (e.g., 64 bits, 128 bits), reducing the area and wiring overhead of the additional permutation logic. Permutation circuitry 432 can also take an immediate value as an input (e.g., as opposed to a permute index register). Permutation circuitry 432 can further be configured to take an immediate input that indicates a zero amount of permutation to be applied to a source variable (e.g., is set to zero), rendering the permutation operation optional. As a result, ALU pipeline 430 can also execute instructions that do not require a permutation operation to be performed before an arithmetic operation. This hardware implementation for lightweight and optional permute logic before an arithmetic operation in a single ALU pipeline 430 can reduce additional area overheads to the ALU 434 and minimize latency overhead to other instructions that do not require permute. Control unit 202 of FIG. 2 can also identify (e.g., by scheduler 312, decoder 314, and/or retire unit 318 of FIG. 3) instruction sequences that involve a permutation before an arithmetic operation and convert them into a single micro-op (uop). Alternatively or additionally, some implementations can utilize a new ISA-level instruction for a permute plus arithmetic operation and a compiler can be modified to leverage this new type of instruction.

An example of a single instruction for a permute plus arithmetic operation can correspond to:

fkppermaddss R1←R1,R2,imm

where fkppermaddss represents an opcode for a permutation operation followed by an addition operation, imm represents an immediate input, and R1 and R2 represent source variables (e.g., register addresses). The immediate input can indicate an amount of permutation (e.g., amount of bit shift to left or right) to be applied to R1 and the source variables can indicate register addresses from which integer operands can be retrieved and/or results can be stored. In some implementations, the above instruction can be generated by fusing the instructions:

fkppermilpdimm R1←R1,imm

fkaddss R1←R1,R2

as discussed above. For example, the control unit 202 of FIG. 2 can retrieve the contents stored at the permute index register address and convert it into an immediate value for inclusion in the single instruction along with the source variables and the opcode for a permutation operation followed by an addition operation. Control unit 202 of FIG. 2 can also select the opcode (e.g., fkppermaddss) for a permutation operation followed by an addition operation based on the opcode (e.g., fkppermilpdimm) for the permutation and the opcode (e.g., fkaddss) for the addition operation.

The identification of instruction sequences for fusing can leverage existing uop fusion logic. For example, identification can be performed in the scheduler, the decoder, and/or the retire stage of the instruction pipeline, converting two dependent uops of permutation followed by arithmetic into a single fused uop. Fused uops can be saved in a uop cache. If an interrupt or exception is raised while executing the fused permute plus arithmetic uop, the control unit 202 of FIG. 2 can disable fusion during a replay and reenable fusion thereafter.

In operation, the permutation circuitry 432 can receive the immediate input 436 and the first source variable 438 and perform the permutation on the first source variable 438 in an amount specified by the immediate input 436. ALU 434 can receive the result of this permutation from permutation circuitry 432, the second source variable 440, and the opcode, and perform the arithmetic operation specified by the opcode using the result of the permutation and the second source variable 440. The result of this arithmetic operation can be the output 442 of the ALU pipeline 430 that can be stored in a destination register specified by the instruction.

ALU pipeline 460 can be an alternative implementation that adds a multiplexer 462 in the ALU pipeline 460. This multiplexer 462 can implement a “zero permute” passthrough of the first source variable 464 to the ALU 466. In some implementations, multiplexer 462 can function like an OR function that can receive as inputs the result of the permutation from the permutation circuitry 468 and the first source variable 464. Multiplexer 462 can provide one or the other of these received inputs to the ALU 466. For example, multiplexer 462 can compare the result of the permutation from the permutation circuitry 468 and the first source variable 464 and can provide the first source variable 464 to the ALU 466 if there is no difference. Otherwise, multiplexer 462 can provide the result of the permutation from the permutation circuitry 468 to the ALU 466. Alternatively, multiplexer 462 can receive an external input signal that governs whether multiplexer 462 provides the result of the permutation or the first source variable 464 to the ALU 466. However, the additional multiplexer logic can increase critical path delay in the ALU pipeline 460. As a result, ALU pipeline 430 can avoid a critical path delay that would result from addition of a multiplexer 462.

FIG. 5 illustrates ALU pipelines 500 and 550 for executing an instruction. ALU pipeline 500 demonstrates an implementation in which the permutation circuitry 502 can be positioned after the ALU 504 in the ALU pipeline 500 in order to execute a single instruction specifying an arithmetic operation that is followed by a permutation. In operation, ALU 504 can receive the first source variable 506, the second source variable 508, and an opcode, and can perform the arithmetic operation specified by the opcode on the first source variable 506 and the second source variable 508. Permutation circuitry 502 can receive the immediate input 510 specified by the instruction and the result of the arithmetic operation from the ALU 504 and can perform the permutation on the received result of the arithmetic operation in an amount specified by the immediate input 510. The result of this permutation can be the output 512 of the ALU pipeline 500 that can be stored in a destination register specified by the instruction.

ALU pipeline 550 demonstrates an implementation in which a first permutation circuitry 552 is positioned before the ALU 554 in the ALU pipeline 550, and a second permutation circuitry 556 is positioned after the ALU 554 in the ALU pipeline 550. ALU pipeline 550 can execute a single instruction specifying a first permutation followed by an arithmetic operation that is followed by a second permutation. In operation, the first permutation circuitry 552 can receive a first immediate input 558 and a first source variable 560 specified by the instruction and perform the permutation on the first source variable 560 in an amount specified by the first immediate input 558. ALU 554 can receive the result of this first permutation from first permutation circuitry 552, the second source variable 562, and the opcode, and perform the arithmetic operation specified by the opcode using the result of the first permutation and the second source variable 562. Second permutation circuitry 556 can receive a second immediate input 564 specified by the instruction and the result of this arithmetic operation from the ALU 554. Second permutation circuitry 556 can perform the second permutation on the result of this arithmetic operation in an amount specified by the second immediate input 564. The result of this permutation can be the output 566 of the ALU pipeline 550 that can be stored in a destination register specified by the instruction.

FIG. 6 illustrates ALU pipelines 600, 630, and 660 for executing an instruction. ALU pipelines 600, 630, and 660 can each have multiple outputs that can be stored in different destination registers specified by a single instruction. For example, ALU pipeline 600 can have the features of ALU pipeline 430 of FIG. 4, but a result of the permutation performed by the permutation circuitry can be stored in a first destination register 602 specified by the instruction and a result of the subsequent arithmetic operation performed by the ALU can be stored in a second destination register 604 specified by the instruction. Additionally, ALU pipeline 630 can have the features of ALU pipeline 500 of FIG. 5, but a result of the arithmetic operation performed by the ALU can be stored in a first destination register 632 specified by the instruction and a result of the subsequent permutation performed by the permutation circuitry can be stored in a second destination register 634 specified by the instruction. Also, ALU pipeline 660 can have the features of ALU pipeline 550 of FIG. 5, but a result of the permutation performed by the first permutation circuitry can be stored in a first destination register 662 specified by the instruction, a result of the subsequent arithmetic operation performed by the ALU can be stored in a second destination register 664 specified by the instruction, and a result of the second permutation performed by the second permutation circuitry can be stored in a third destination register 666 specified by the instruction. ALU pipelines with multiple outputs can potentially increase the coverage of two or more dependent instructions that involve one or more permutations before and/or after an arithmetic operation. However, increased implementation overheads can be required to support two or more outputs per ALU pipeline.

As set forth above, by performing, by permutation circuitry, a permutation in response to an instruction specifying a single operation that includes an arithmetic operation and performing, by an arithmetic logic unit (ALU), the arithmetic operation in response to the instruction, the disclosed systems and methods can achieve numerous benefits. For example, certain implementations of the disclosed systems and methods can reduce the number of instruction cycles required to execute two or more dependent instructions that involve a permutation and an arithmetic operation by fusing them into a single instruction. Executing both permute and arithmetic operations in a single ALU pipeline can result in lower instruction count and reduced resource (e.g., scheduler) pressure. Additional benefits can include latency improvement, reduced contention, and reduced instruction count (e.g., for implementations having an explicit instruction set architecture (ISA) instruction).

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
permutation circuitry configured to perform a permutation in response to an instruction that includes an arithmetic operation; and
an arithmetic logic unit configured to perform the arithmetic operation in response to the instruction.

2. The device of claim 1, wherein the permutation circuitry is configured to perform a zero amount of permutation based on a static value that is included in the instruction and that indicates a zero value.

3. The device of claim 1, wherein the permutation circuitry is configured to perform the permutation on a first source variable based on static value, the first source variable and the static value being specified by the instruction.

4. The device of claim 3, wherein the arithmetic logic unit is configured to perform the arithmetic operation on the permuted first source variable and a second source variable, the arithmetic operation and the second source variable also being specified by the instruction.

5. The device of claim 1, wherein:
the arithmetic logic unit is configured to perform the arithmetic operation on a first source variable and a second source variable, the first source variable and the second source variable being specified by the instruction; and
the permutation circuitry is configured to perform the permutation on an output of the arithmetic logic unit based on a static value specified by the instruction.

6. The device of claim 1, wherein:
the arithmetic logic unit is configured to store its output to a first destination register; and
the permutation circuitry is configured to store its output to a second destination register.

7. The device of claim 1, wherein the permutation circuitry is configured to perform the permutation within a first word size less than a second word size within which the arithmetic logic unit is configured to perform additional permutations.

8. The device of claim 1, wherein the device is further configured to fuse two or more dependent instructions that involve one or more permutations at least one of before or after the arithmetic operation into the instruction.

9. The device of claim 8, wherein the device is configured to store the instruction in a cache.

10. The device of claim 8, wherein the device is configured to disable fusing in response to at least one of an interrupt or an exception raised while executing the instruction.

11. The device of claim 1, further comprising a multiplexer configured to:
receive an input to the permutation circuitry;
receive an output of the permutation circuitry; and
provide only one of the received input or the received output to the arithmetic logic unit.

12. A system comprising:
a fusion logic unit configured to fuse two or more dependent instructions that involve one or more permutations at least one of before or after an arithmetic operation into an instruction that includes the arithmetic operation; and
one or more arithmetic logic unit pipelines, wherein at least one of the one or more arithmetic logic unit pipelines includes permutation circuitry configured to perform a permutation in response to the instruction and an arithmetic logic unit configured to perform the arithmetic operation in response to the instruction.

13. The system of claim 12, further comprising:
a cache configured to store the instruction.

14. The system of claim 12, wherein the two or more dependent instructions are identified by at least one of:
one or more schedulers of a processor back end;
one or more decoders of a processor front end; or
a retire unit.

15. The system of claim 12, wherein the permutation circuitry is configured to perform a zero amount of permutation based on a static value that is included in the instruction and that indicates a zero value.

16. A method, comprising:
performing, by permutation circuitry, a permutation in response to an instruction that includes an arithmetic operation; and
performing, by an arithmetic logic unit, the arithmetic operation in response to the instruction.

17. The method of claim 16, further comprising performing a zero amount of permutation based on a static value that is included in the instruction and that indicates a zero value.

18. The method of claim 16, further comprising performing the permutation on a first source variable based on a static value, the first source variable and the static value being specified by the instruction.

19. The method of claim 16, further comprising performing the permutation, by the permutation circuitry, within a first word size less than a second word size within which the arithmetic logic unit is configured to perform additional permutations.

20. The method of claim 16, further comprising:
fusing two or more dependent instructions that involve one or more permutations at least one of before or after the arithmetic operation into the instruction.
